(19) United States
(12) Patent Application Publication
(10) Pub. No.: US 2025/0373302 A1
(43) Pub. Date: Dec. 4, 2025

(54) INTER-FREQUENCY L1 CSI REPORT FOR L1/L2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/877,183

(22) PCT Filed: Aug. 9, 2022
(86) PCT No.: PCT/CN2022/111077

§ 371 Date: Dec. 19, 2024

(51) Int. Cl. H04B 7/06; H04L 5/00; H04L 27/26; H04W 24/10

(52) U.S. Cl. CPC H04B 7/0626; H04L 5/0007; H04L 27/26025; H04W 24/10

(57) ABSTRACT

Aspects presented herein may enable a UE to perform inter-frequency L1 measurement for one or more neighboring (e.g., non-serving) cells, and to report L1 CSI report for L1/L2 mobility. In one aspect, a UE receives a configuration to perform an SSB-based inter-frequency measurement or a CSI-RS-based inter-frequency measurement for a non-serving cell, where the configuration is received from a network entity. The UE measures a set of SSBs or a set of CSI-RSs transmitted from the non-serving cell based on the configuration, where the set of SSBs or the set of CSI-RSs corresponds to a different frequency than an SSB or a CSI-RS of a serving cell. The UE transmits a CSI report associated with the non-serving cell to the network entity, where the CSI report is transmitted based on the measurement of the set of SSBs or the set of CSI-RSs.

### TECHNICAL FIELD

The present disclosure relates generally to communication systems, and more particularly, to a wireless communication involving channel state information (CSI) reporting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives a configuration to perform a synchronization signal block (SSB)-based inter-frequency measurement or a channel state information reference signal (CSI-RS)-based inter-frequency measurement for a non-serving cell, where the configuration is received from a network entity. The apparatus measures a set of SSBs or a set of CSI-RSs transmitted from the non-serving cell based on the configuration, where the set of SSBs or the set of CSI-RSs corresponds to a different frequency than an SSB or a CSI-RS of a serving cell. The apparatus transmits a channel state information (CSI) report associated with the non-serving cell to the network entity, where the CSI report is transmitted based on the measurement of the set of SSBs or the set of CSI-RSs.

In an aspect of the disclosure, a method, a computer-readable medium, and an apparatus are provided. The apparatus transmits a configuration to perform an SSB-based inter-frequency measurement or a CSI-RS-based inter-frequency measurement for a non-serving cell of a user equipment (UE), where the configuration is transmitted to the UE. The apparatus receives a CSI report associated with the non-serving cell from the UE, where the CSI report is received based on a measurement of a set of SSBs or a set of CSI-RSs transmitted from the non-serving cell, where the set of SSBs or the set of CSI-RSs corresponds to a different frequency than an SSB or a CSI-RS of a serving cell of the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example inter-cell mobility of a UE in accordance with various aspects of the present disclosure.

FIG. 5 is a diagram illustrating an example inter-cell mobility of a UE in accordance with various aspects of the present disclosure.

FIG. 6A is a diagram illustrating an example of a UE selecting a single primary cell (PCell) without carrier aggregation (CA) or dual connectivity (DC) among a pre-configured candidate PCell set in accordance with various aspects of the present disclosure.

FIG. 6B is a diagram illustrating an example of a UE performing a PCell change based on swapping a PCell with a secondary cell (SCell) in CA among a pre-configured candidate PCell set in accordance with various aspects of the present disclosure.

FIG. 7 is a communication flow illustrating an example of a UE performing an inter-frequency layer one (L1) measurement for mobility in accordance with aspects of the present disclosure.

FIG. 8 is a diagram illustrating an example measurement gap in accordance with various aspects of the present disclosure.

FIG. 9 is a flowchart of a method of wireless communication.

FIG. 10 is a diagram illustrating an example of a hardware implementation for an example apparatus and/or network entity.

FIG. 11 is a flowchart of a method of wireless communication.

FIG. 12 is a diagram illustrating an example of a hardware implementation for an example apparatus and/or network entity.

### DETAILED DESCRIPTION

Aspects presented herein may enable a UE to perform inter-frequency L1 measurement for one or more neighboring (e.g., non-serving) cells, and to report L1 CSI report for L1/L2 mobility. Aspects presented herein may enable a UE to perform inter-frequency handover between cells to improve the mobility of the UE. As such, a UE may be configured with a dynamic switch mechanism among a set of candidate serving cells (including SpCell and SCell) for applicable scenarios based on L1/L2 signaling. In addition, aspects presented herein may provide L1 enhancements for inter-cell beam management, which may include L1 measurement, reporting, and/or beam indication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

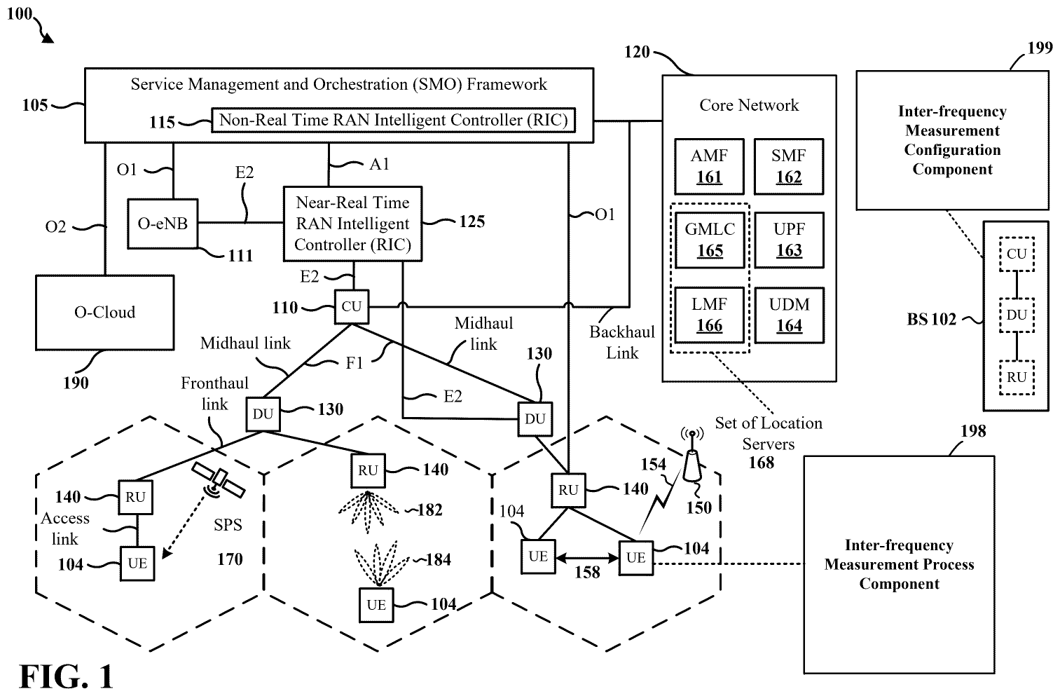

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive a configuration to perform an SSB-based inter-frequency measurement or a CSI-RS-based inter-frequency layer 1 (L1) measurement for a non-serving cell, where the configuration is received from a network entity; measure a set of SSBs or a set of CSI-RSs transmitted from the non-serving cell based on the configuration, where the set of SSBs or the set of CSI-RSs corresponds to a different frequency than an SSB or a CSI-RS of a serving cell; and transmit an L1 CSI report associated with the non-serving cell to the network entity, where the CSI report is transmitted based on the measurement of the set of SSBs or the set of CSI-RSs (e.g., via the inter-frequency measurement process component 198). In certain aspects, the base station 102 may be configured to transmit a configuration to perform an SSB-based inter-frequency measurement or a CSI-RS-based inter-frequency L1 measurement for a non-serving cell of a UE, where the configuration is transmitted to the UE; and receive a L1 CSI report associated with the non-serving cell from the UE, where the CSI report is received based on a measurement of a set of SSBs or a set of CSI-RSs transmitted from the non-serving cell, where the set of SSBs or the set of CSI-RSs corresponds to a different frequency than an SSB or a CSI-RS of a serving cell of the UE (e.g., via the inter-frequency measurement configuration component 199).

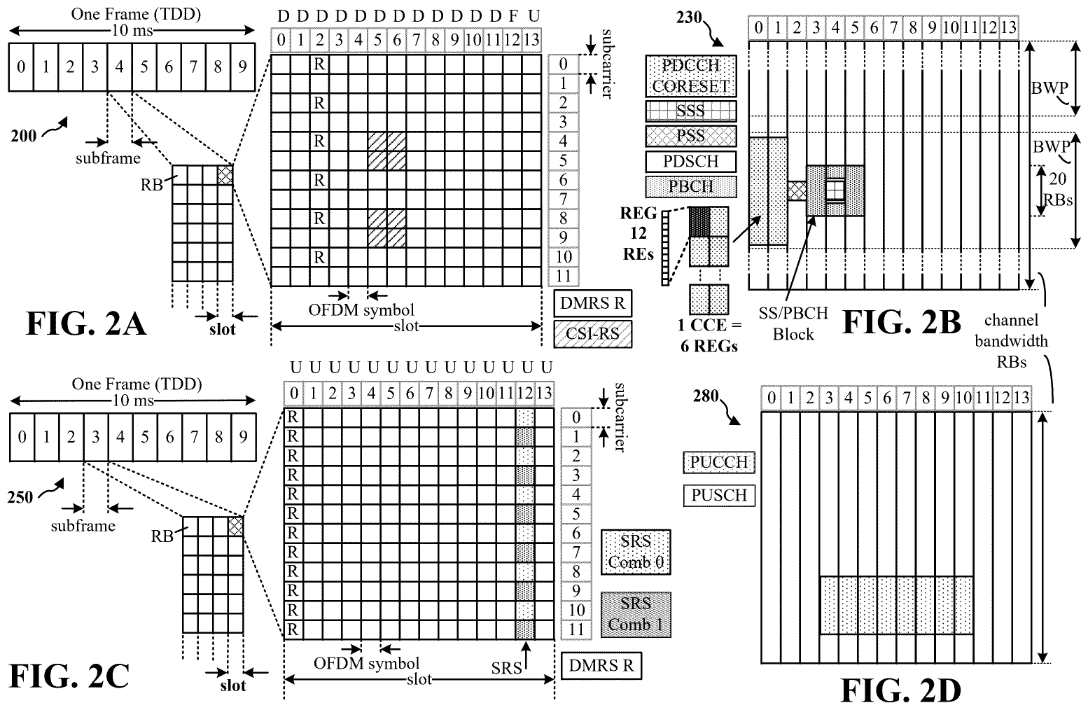

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

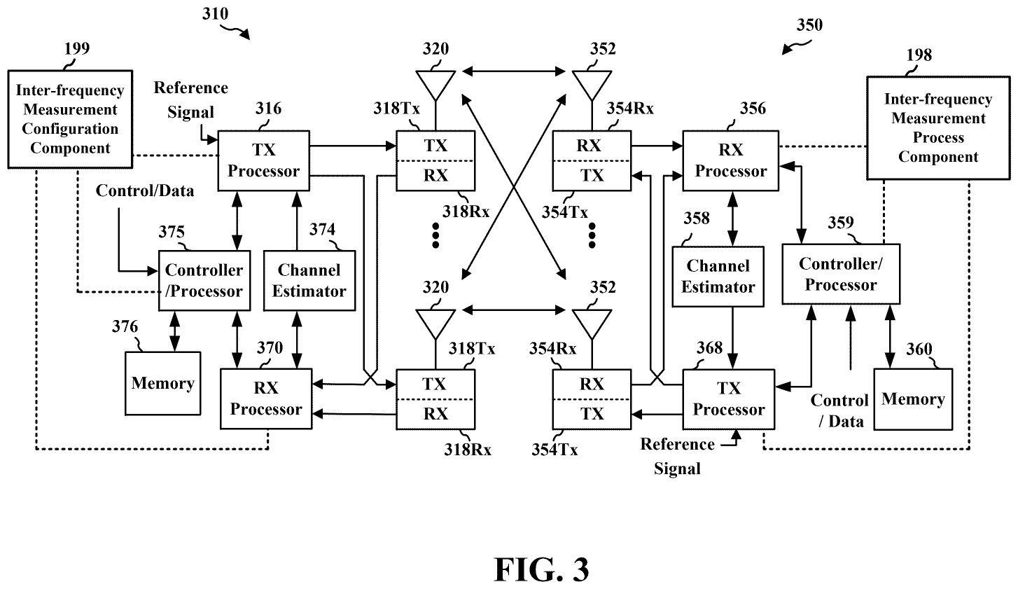

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the inter-frequency measurement process component 198 of FIG. 1.

At least one of the TX processor 316, the RX processor 370, and the controller/processor 375 may be configured to perform aspects in connection with the inter-frequency measurement configuration component 199 of FIG. 1.

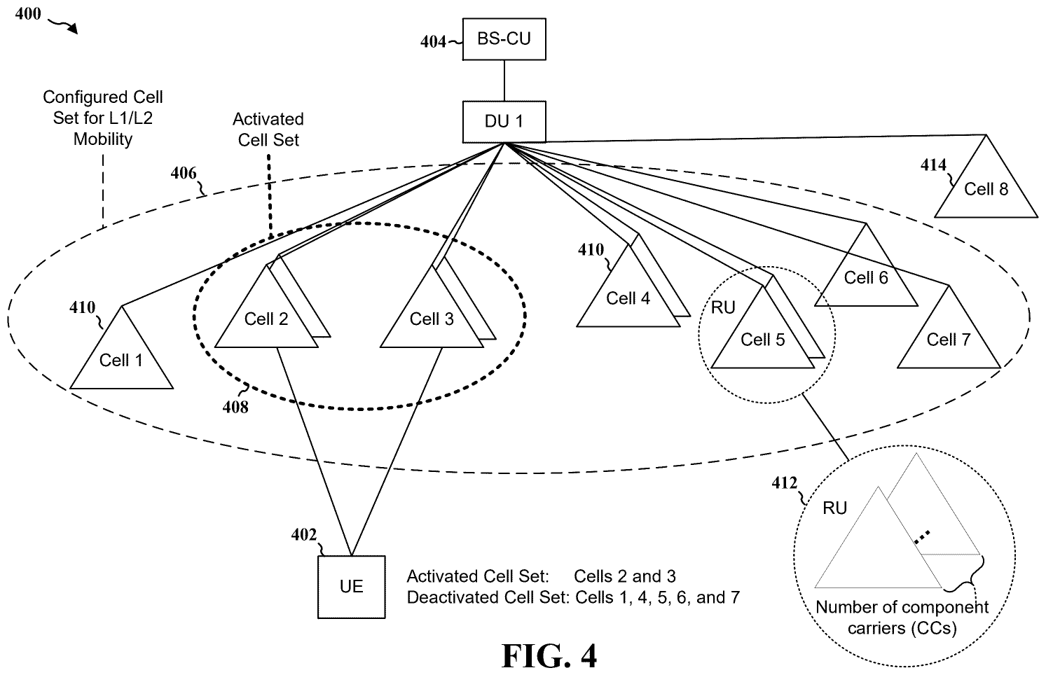

FIG. 4 is a diagram 400 illustrating an example inter-cell mobility of a UE in accordance with various aspects of the present disclosure. As a UE 402 moves from one location to another location, the UE 402 may be configured to perform layer one (L1) (e.g., physical layer) and/or layer two (L2) (e.g., medium access control (MAC) layer) based inter-cell mobility (which may also be referred to as “L1/L2 mobility” hereafter). Under inter-cell mobility, the UE 402 may be connected to a base station 404 (e.g., via a distributed unit (DU) of the base station 404), and the UE 402 may be handed over from one cell (or one group of cell) to another cell (or another group of cell) without implementing a radio resource control (RRC) anchor change (e.g., the UE 402 maintains its connection with the base station 404).

As shown at 406, for the UE 402 to perform the L1/L2 mobility, the base station 404 may configure the UE 402 with a set of cells (e.g., cells 1 to 7) via an RRC configuration, which may be referred to as an L1/L2 mobility configured cell set (or simply a configured cell set). Each cell with a configured cell set may be referred to as a configured cell. The L1/L2 mobility configured cell set may further include an L1/L2 mobility activated cell set (or simply an activated cell set) and an L1/L2 mobility deactivated cell set (or simply a deactivated cell set). As shown at 408, the activated cell set may refer to a group of cells (e.g., activated cells 2 and 4) in the configured cell set that are activated and can be readily used between the UE 402 and the base station 404 for data and control transfer. On the other hand, as shown at 410, the deactivated cell set may refer to a group of cells (e.g., deactivated cells 1, 4, 5, 6, and 7) in the configured cell set that are deactivated and can be readily activated (e.g., to become part of the active cell set) by L1/L2 signaling (but may not be readily used for data and control transfer until activated). Cells in both the activated cell set and the deactivated cell set may be considered as serving cells under the L1/L2 mobility, and each cell may include multiple component carriers (CCs). The cells in the configured cell sets may belong to the same DU or different DUs. The base station 404 may continue to proactively configure the UE 402 with a new set of cells based on the UE 402′s mobility via RRC signaling (e.g., by adding cell(s) to and/or removing cell(s) from the configured list of cells).

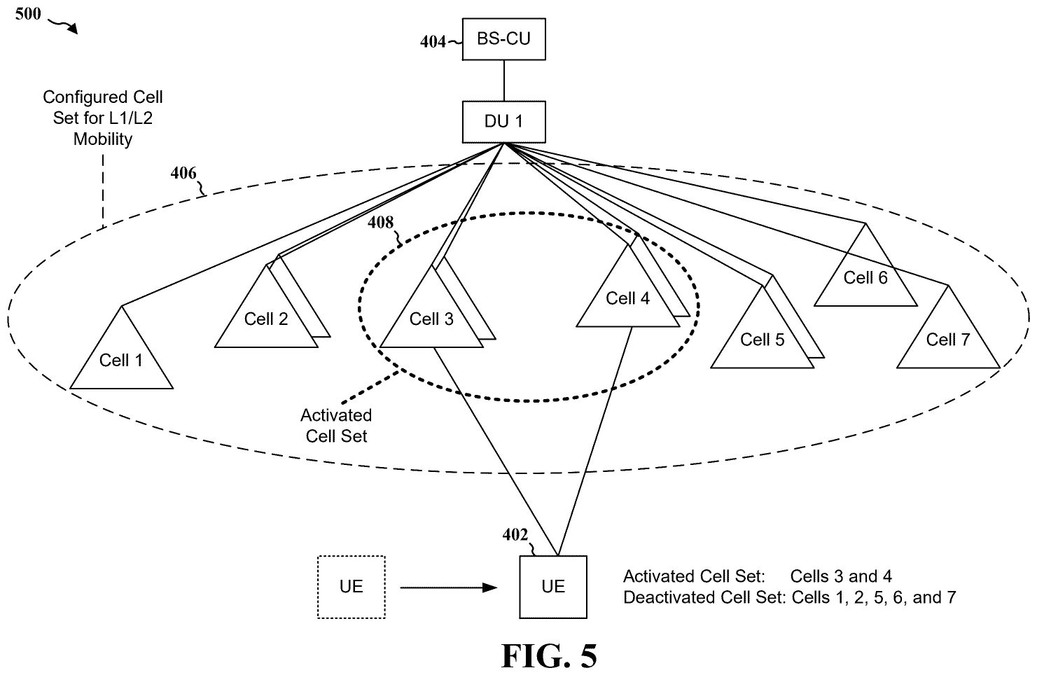

To facilitate seamless mobility within the cells in the activated cell set (which may be referred to as activated cells), L1/L2 signaling may be used between the UE 402 and the base station 404 to activate/deactivate cells in the configured cell set and to select beams within the activated cells. In other words, the mobility management of the activated cells sets and the deactivated cell sets may be based on L1/L2 signaling instead of layer three (L3) (e.g., the network layer, RRC) signaling as L1/L2 signaling generally takes less time to perform compared to the L3 signaling. As such, as the UE 402 moves, the cells from the configured cell set may be deactivated and activated via L1/L2 signaling. For example, as shown by a diagram 500 of FIG. 5, after the UE 402 moves to another location, cell 4 may be activated and cell 2 may be deactivated via L1/L2 signaling between the UE 402 and the base station 404.

In some example, the inter-cell mobility may be based on the signal quality (e.g., measurements such as reference signal received power (RSRP), signal to interference and noise ratio (SINR), etc.) and/or based on the loading of the cells. In some configurations, cells in the L1/L2 mobility configured cell set may belong to the same DU, which may be similar to carrier aggregation (CA) but the cells may be on the same carrier frequencies. In most implementations, the configured cell set configured for the UE 402 is large enough to cover a meaningful mobility area.

The UE 402 may be provided with a subset of deactivated cells (which may be referred to as a candidate cell set) in which the UE 402 may autonomously choose to add to the activated cell set, such as based on measured channel quality, the loading information, etc. For example, as shown by the diagram 400 of FIG. 4, the UE 402 may be provided with a deactivated cell set that includes deactivated cells 1, 4, 5, 6, and 7. Then, as shown by the diagram 500 of FIG. 5, as the UE 402 moves, the UE 402 may measure and determine that the channel quality for the activated cell 2 has dropped below a signal threshold or has a high traffic load (e.g., the number of users connected exceeds a traffic threshold). In response, the UE 402 may autonomously add the deactivated cell 4 to the activated cell set. In some examples, this may be similar to conditional handover for fast and efficient addition of the prepared cells.

Referring back to FIG. 4, as shown at 412, each of the RUs (e.g., the RUs 140 described in connection with FIG. 1) that is connected to the DU of the base station 404 may have multi-carrier (e.g., N CCs) support, where each CC is a cell. As such, activation/deactivation of cells may be done based on groups of carriers (e.g., cells).

To manage a primary cell (PCell), L1/L2 signaling may also be used by the UE 402 and the base station 404 to set a PCell out of one or more preconfigured options within the activated cell set. For some network, L3 mobility (e.g., L3 signaling) may be used for PCell change (e.g., L3 handover) when a new PCell is not from the activated cell set for L1/L2 mobility, where RRC signaling may be used for updating the set of cells for L1/L2 mobility at L3 handover. For purposes of the present disclosure, a special cell (SpCell/spCell/sPCell) may include a PCell and primary secondary cell(s) (PSCell) (e.g., SpCell=PCell+PSCell).

Aspects presented herein may improve the latency and efficiency of L1/L2 inter-cell mobility. In one aspect, to facilitate fast and efficient cell management using L1/L2 signaling, aspects presented herein may enable cells in the L1/L2 mobility configured cell set to include both valid SCell and SpCell configurations. As such, when a base station updates a cell to become an SpCell or an SCell for a UE, the UE may have the right configuration to apply. In another aspect, for L1/L2 mobility cell within carrier aggregation framework, as a large number of cells may be present in the L1/L2 mobility configured cell set, aspects presented herein provide procedures and signaling that enable efficient cell configuration for L1/L2 mobility. For example, delta signaling may be used for L1/L2 mobility specific configuration and/or for general cell configuration, which may be different from the delta configuration that applies to PCell during L3 handover.

In some scenarios, a UE (e.g., the UE 402) may be configured to perform L1 measurement for one or more neighboring cells (e.g., non-serving cells), which may also be referred to as neighboring physical cell identifications (PCIs). For example, referring back to FIG. 4, as shown at 414, the UE 402 may be configured to measure a non-serving cell 8 (e.g., a cell not in the configured cell set), and to report the measurement to the base station 404. In some examples, a UE may be able to measure a neighboring cell (e.g., a non-serving cell) based on intra-frequency, where the neighbor cell is operating at the same frequency as a serving cell, such as transmitting a synchronization signal block (SSB) with the same center frequency and subcarrier spacing (SCS) as an SSB from the serving cell. However, the UE may not be able to measure a neighbor cell based on inter-frequency, where the neighbor cell is operating at a different frequency and/or SCS than a serving cell, such as transmitting an SSB with a different center frequency and/or a different SCS than an SSB from the serving cell. In addition, a UE may be configured with a measurement gap for an L3 mobility measurement (e.g., a measurement gap is linked to an L3 measurement configuration. However, for an L1 measurement, such as for an inter-cell beam management (BM) and/or for a multiple transmission and reception points (multi-TRPs or mTRP) scenario, a measurement gap may not be specified or configured for a UE since the non-serving cell SSB has the same center frequency and SCS as the serving cell SSB, and the non-serving cell SSB may be contained inside an active downlink (DL) bandwidth part (BWP) of the serving cell. For purposes of the present disclosure, a for a UE in an RRC connected state not configured with carrier aggregation (CA) there may be just one serving cell including the primary cell. For a UE in an RRC connected state configured with CA the term “serving cells” may be used to denote a set of one or more cells including the primary cell and all secondary cells. A non-serving cell may refer to a cell that is not a serving cell.

Aspects presented herein may enable a UE to perform inter-frequency L1 measurement for one or more neighboring (e.g., non-serving) cells, and to report L1 CSI report for L1/L2 mobility. Aspects presented herein may enable a UE to perform inter-frequency handover between cells to improve the mobility of the UE. As such, a UE may be configured with a dynamic switch mechanism among a set of candidate serving cells (including SpCell and SCell) for applicable scenarios based on L1/L2 signaling. In addition, aspects presented herein may provide L1 enhancements for inter-cell beam management, which may include L1 measurement, reporting, and/or beam indication.

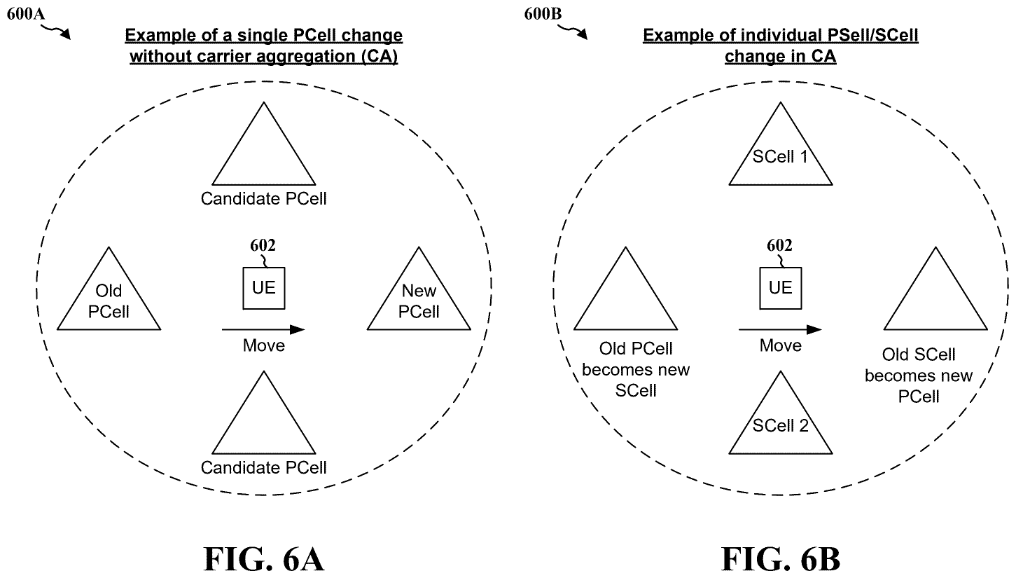

In some scenarios, for an individual cell selection, there may be a separate or different signaling for PCell change and SCell change, respectively, depending on whether there is a carrier aggregation (CA). In addition, an SCell selection may be performed a UE and a serving base station based on L1/L2 signaling. FIG. 6A is a diagram 600A illustrating an example of a UE selecting a single PCell without CA or dual connectivity (DC) among a pre-configured candidate PCell set in accordance with various aspects of the present disclosure. A UE 602 may be configured with a set of candidate PCells by a base station, such as described in connection with FIGS. 4 and 5. As the UE 602 moves, the base station may handover the UE 602 from a current PCell to a new PCell among the set of candidate PCells. For example, the base station may request the UE 602 to measure the set of candidate PCells and report the measurement (e.g., via a CSI report) to the base station. Based on the measurement, the base station may determine which PCell to handover the UE 602. FIG. 6B is a diagram 600B illustrating an example of a UE performing a PCell change based on swapping a PCell with an SCell (PCell↔SCell) in CA among a pre-configured candidate PCell set in accordance with various aspects of the present disclosure. A UE 602 may be configured with a set of SCells by a base station. As the UE 602 moves, the base station may swap the UE 602 from a current PCell to an SCell among the set of SCells, such that the current PCell may become a new SCell in the set of SCells, and the SCell in which the UE is swapped to may become the new PCell. Similarly, the base station may determine which PCell/SCell to swap based on the measurement report for the set of SCells from the UE 602.

In one aspect of the present disclosure, a UE may be configured to perform SSB and/or channel state information reference signal (CSI-RS)-based inter-frequency L1 measurement for channel measurement(s) in an L1 CSI report. For example, a base station may configure a UE, via a serving cell, to measure one or more neighboring cells that are transmitting SSBs and/or CSI-RSs that have different center frequencies or SCSs than the SSBs/CSI-RSs transmitted from the serving cell. Then, the UE may transmit the inter-frequency measurements for the one or more neighboring cells to the base station, such as via an L1 CSI report. In response, the base station may determine which neighboring cell(s) may be configured for the UE for L1/L2 mobility (e.g., to be added into a configured cell set as described in connection with FIGS. 4 and 5). In one example, the UE may be configured to perform the SSB-based inter-frequency measurement and/or the CSI-RS-based inter-frequency measurement (hereafter collectively as the “SSB/CSI-RS-based inter-frequency measurement”) without measurement gap(s) if the inter-frequency SSB/CSI-RS (e.g., SSB/CSI-RS transmitted from the neighboring cell(s)) is completely contained in an active DL BWP of the serving cell. In another example, the UE may be configured to perform the SSB/CSI-based inter-frequency L1 measurement with measurement gap(s) if the inter-frequency SSB/CSI is at least partially outside an active DL BWP of the serving cell.

For purposes of the present disclosure, an SSB-based inter-frequency L1 measurement may refer to a measurement where the center frequency of the SSB of the serving cell and the center frequency of the SSB of the neighboring cell are different, or the SCS of the two SSBs is different. A CSI-RS-based intra-frequency measurement may refer to a measurement where the SCS of CSI-RS resources on the neighboring cell configured for measurement is the same as the SCS of CSI-RS resources on the serving cell indicated for measurement; and for 60 kHz SCS, the cyclic prefix (CP) type of CSI-RS resources on the neighboring cell configured for measurement is the same as the CP type of CSI-RS resources on the serving cell indicated for measurement; and the center frequency of CSI-RS resources on the neighboring cell configured for measurement is the same as the center frequency of CSI-RS resource on the serving cell indicated for measurement. A CSI-RS based inter-frequency measurement may refer to a measurement that is not a CSI-RS based intra-frequency measurement.

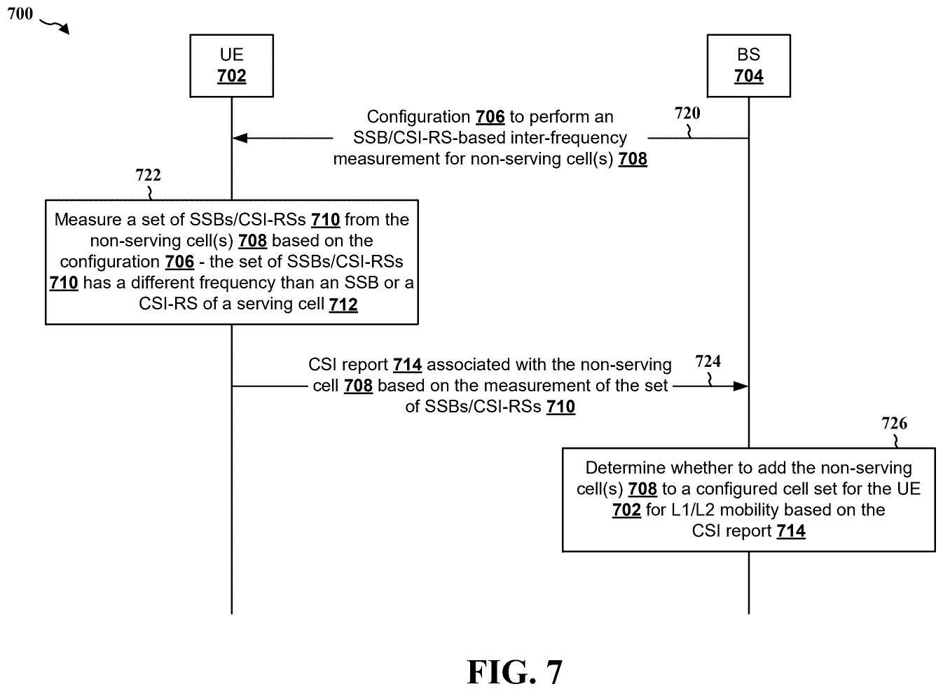

FIG. 7 is a communication flow 700 illustrating an example of a UE performing an inter-frequency L1 measurement for mobility in accordance with aspects of the present disclosure. The numberings associated with the communication flow 700 do not specify a particular temporal order and are merely used as references for the communication flow 700. Aspects presented herein may enable a base station to configure a UE to perform an SSB/CSI-RS-based inter-frequency L1 measurement for one or more neighboring cells, and to report the measurement for L1/L2 mobility.

At 720, a base station 704 (or a component of the base station 704) may transmit a configuration 706 to a UE 702 to configure the UE 702 to perform an SSB-based inter-frequency measurement and/or a CSI-RS-based inter-frequency measurement (hereafter “SSB/CSI-RS-based inter-frequency measurement”) for at least one non-serving cell 708. The base station 704 may transmit the configuration 706 via radio resource control (RRC) signaling or an RRC message.

At 722, based on the configuration 706, the UE 702 may measure a set of SSBs or a set of CSI-RSs (hereafter “SSBs/CSI-RSs 710”) transmitted from the at least one non-serving cell 708. The SSBs/CSI-RSs 710 may correspond to a different frequency than an SSB or a CSI-RS of a serving cell 712. For example, the frequency of an SSB of the serving cell 712 and an SSB of the at least one non-serving cell 708 may be different, or the SCSs of the two SSBs may be different, and/or the frequency of a CSI-RS of the serving cell 712 and a CSI-RS of the at least one non-serving cell 708 may be different, or the SCSs of the two CSI-RSs may be different, etc. The serving cell 712 may include at least one serving cell (e.g., PCell), and the at least one non-serving cell 708 may also be referred to as a neighbor cell.

In one aspect of the present disclosure, the configuration 706 includes a measurement gap if the SSBs/CSI-RSs 710 are at least partially outside of an active DL BWP of the serving cell 712 (e.g., at least the bandwidth or the duration of the SSBs/CSI-RSs 710 exceeds or is outside of the active DL BWP) or have an SCS different from the SCS of the active DL BWP of the serving cell 712. On the other hand, the configuration 706 does not include a measurement gap if the SSBs/CSI-RSs 710 are contained inside an active DL BWP of the serving cell 712 (e.g., the bandwidth and the duration of the SSBs/CSI-RSs 710 does not exceed the active DL BWP) and have an SCS same as the SCS of the active DL BWP of the serving cell 712.

At 724, after the measurement of the set of SSBs/CSI-RSs 710 for the at least one non-serving cell 708, the UE 702 may transmit a corresponding CSI report 714 (e.g., an L1 CSI report) to the base station 704.

In one example, the base station 704 may configure the UE 702 with additional reference signals (e.g., other types of reference signals other than CSI-RS) from the at least one non-serving cell 708 for the measurement and/or additional neighboring cell(s) (or neighboring PCI(s)) for the CSI report 714, such as via the configuration 706 or a separate configuration. For example, the base station 704 may transmit an RRC configuration to the UE 702 that includes a reference signal configuration parameter (e.g., ReferenceSignalConfig) which includes SSBs and/or CSI-RSs configured for mobility. If the RRC configuration includes SSBs configured for mobility, the RRC configuration may include a set of SSBs to be measured by the UE 702. For example, the set of SSBs to be measured may be configured by an SSB measurement timing configuration (SMTC), which may include any of: a parameter “periodicityAndOffset” indicating a periodicity and offset, a parameter “duration” indicating a duration of the measurement window in which to receive SSB blocks, a parameter “pci-List” indicating a list of physical cell indexes, and/or a parameter “ssb-ToMeasure” indicating a set of SSB indexes to measure. If the RRC configuration includes CSI-RSs configured for mobility, the RRC configuration may include the configuration for a set the CSI-RSs (e.g., resources for the set of CSI-RSs, its periodicity, etc.). If the set of CSI-RSs is not associated with an SSB, the RRC configuration may also include a timing reference for the set of CSI-RSs. For example, the RRC configuration may include a reference serving cell index parameter (e.g., refServCellIndex), which indicates the serving cell providing the timing reference for CSI-RS resources without associated SSB.

In another example, if the configuration 706 configures the UE 702 to perform the SSB-based inter-frequency measurement (e.g., inter-frequency measurement for a set of SSBs from a non-serving cell), the configuration 706 may include: inter-frequency information for the set of SSBs (e.g., via an ssbFrequency parameter), an SCS for the set of SSBs (e.g., via an ssbSubcarrierSpacing parameter), an SSB measurement timing configuration information (e.g., a window for measuring the set of SSBs) (which may also be referred to as an SSB-based radio resource management (RRM) measurement timing configuration (SMTC) window, an associated measurement gap configuration information if a measurement gap is configured (e.g., via an associatedMeasGapSSB parameter), or a combination thereof. On the other hand, if the configuration 706 configures the UE 702 to perform the CSI-RS-based inter-frequency measurement (e.g., inter-frequency measurement for a set of CSI-RSs from a non-serving cell), the configuration 706 may include: inter-frequency information for the set of CSI-RSs (e.g., via a refFreqCSI-RS parameter), the SCS for the set of CSI-RSs, and/or the associated measurement gap configuration information if a measurement gap is configured (e.g., via an associatedMeasGapCSIRS parameter). The configuration 706 may be configured under a channel measurement resource configuration (e.g., a CSI resource setting by RRC configuration “CSI-ResourceConfig”) associated with a L1 CSI report.

In another example, if the configuration 706 configures the UE 702 to perform the SSB-based inter-frequency measurement (e.g., inter-frequency measurement for a set of SSBs from a non-serving cell), the configuration 706 may be a CSI resource setting by RRC configuration (e.g., CSI-ResourceConfig) associated with an L1 CSI report. For example, the CSI resource setting may be configured to include one or more of: a resource setting ID such as a parameter “csi-SSB-ResourceSetId”, an SSB list such as a parameter “csi-SSB-ResourceList”, a list of PCIs such as a parameter “additionalPCIList” with each PCI for a SSB in the SSB list, and associated measurement gap configuration such as a parameter “associatedMeasGapSSB.” In some examples, a set of SSBs corresponding to one PCI in the configuration 706 may be indicated by an RRC configuration “SSB-MTC-AdditionalPCP”' as below:

```
  SSB-MTC-AdditionalPCI ::= SEQUENCE {
      additionalPCIIndex AdditionalPCIIndex,
      additionalPCI PhysCellId,
      periodicity,
      ssb-PositionsInBurst,
      ss-PBCH-BlockPower,
      ssbFrequency,
    ssbSubcarrierSpacing
}
```

where a parameter “additionalPCIIndex” and “additionalPCI”' is to determine a physical cell index for the set of SSBs, and the parameter “periodicity” is to determine the periodicity for the set of SSBs, the parameter “ssb-PositionsInBurst” is to determine SSB positions to be measured, and the parameter “ss-PBCH-BlockPower” is to determine the transmit power for the set of SSBs, and the parameter “ssbFrequency” is to determine the frequency for the set of SSBs, the parameter “ssbSubcarrierSpacing” is to determine the SCS for the set of SSBs.

At 726, based on the CSI report 714, the base station 704 may determine whether to add the at least one non-serving cell 708 to a configured cell set for the UE 702 for L1/L2 mobility, such as described in connection with FIGS. 4 and 5.

In another aspect of the present disclosure, if a UE (e.g., the UE 402, 602, 702) is configured by a serving base station (e.g., the base station 404, the base station 704) to perform a measurement of SSBs/CSI-RSs from a non-serving cell on a different frequency (i.e., to perform the SSB/CSI-RS-based inter-frequency measurement), the serving base station may include at least one measurement gap in the configuration.

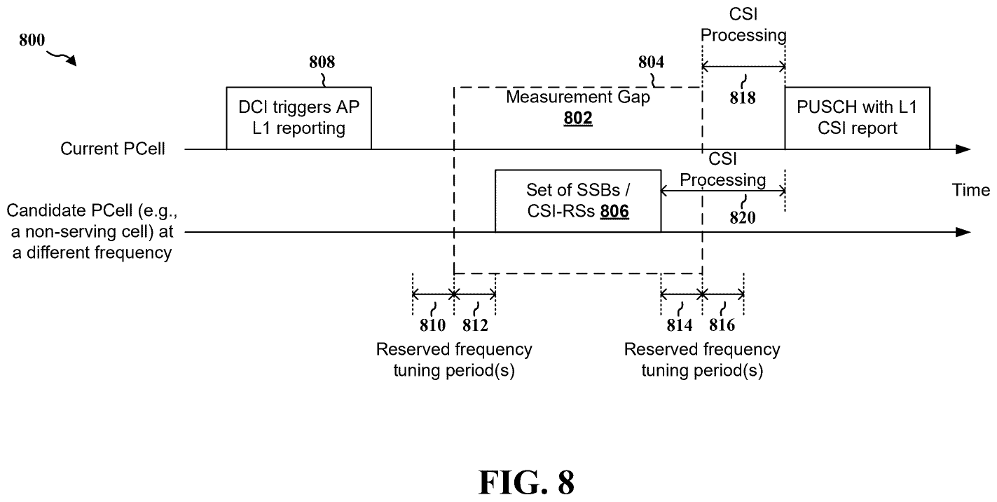

FIG. 8 is a diagram 800 illustrating an example measurement gap in accordance with various aspects of the present disclosure. In one example, as shown at 804, a measurement gap 802 may be provided to a UE (e.g., the UE 402, 602, 702) if the UE is configured to perform an L1 measurement for non-serving SSBs/CSI-RSs 806 on a different frequency, such that the UE may utilize the measurement gap 802 for measuring the non-serving SSBs/CSI-RSs 806. The configured measurement gap 802 may be linked to/associated with an L1 measurement/report configuration.

In one example, the measurement gap 802 may be linked to/associated with an L1 measurement and/or a CSI reporting. For example, as shown at 808, the UE may be configured to perform a semi-persistent (SP) or an aperiodic (AP) L1 CSI reporting by a serving base station (e.g., triggered via downlink control information (DCI)) (e.g., the base station 404, the base station 704). If the SP/AP L1 CSI reporting is associated with a measurement of the non-serving SSBs/CSI-RSs 806 on a different frequency or a different SCS, then the configuration may also include the measurement gap 802, such as between two CSI porting instances of the SP/AP L1 CSI reporting. As such, the base station may use L1/L2 signaling to activate/trigger the SP/AP L1 measurement/CSI reporting together with the measurement gap 804 at the UE. The measurement gap 802 may be configured in a CSI report configuration, or in a CSI resource setting configuration.

In another aspect of the present disclosure, the UE may also reserve frequency tuning period(s) before the start (as shown at 810) or after the start (as shown at 812) of the measurement gap 802, and/or before the end (as shown at 814) or after the end (as shown at 816) of the measurement gap 802, where the UE may use the frequency tuning period(s) for performing frequency/antenna tuning for measuring SSB/CSI-RS at a different frequency.

In another aspect of the present disclosure, as it may take time for a UE to process and prepare the CSI report after measuring the set of SSBs/CSI-RSs 806. Thus, a CSI processing timeline specification may also be defined/configured for the UE, such that the UE has sufficient time to process the CSI report. In one example, as shown at 818, a CSI processing timeline specification may be defined for a time duration between a last orthogonal frequency-division multiplexing (OFDM) symbol of an associated measurement gap (e.g., the measurement gap 802) and a first OFDM symbol of the SP/AP CSI reporting (e.g., the next SP/CSI reporting instance). In another example, as shown at 820, the CSI processing timeline specification may be defined for a time duration between a last OFDM symbol of the set of SSBs/CSI-RSs 806 (e.g., the last symbol of the last SSB/CSI-RS in the set of SSBs/CSI-RSs 806) and the first OFDM symbol of the AP/SP CSI reporting. As such, when periodic, aperiodic, or semi-persistent CSI-RS/channel state information-interference measurement (CSI-IM) or SSB is used for channel/interference measurements, the UE is not expected to measure channel/interference on the CSI-RS/CSI-IM/SSB whose last OFDM symbol of an associated measurement gap is received up to Z′ symbols before transmission time of the first OFDM symbol of the aperiodic/periodic/semi-persistent CSI reporting. In other words, the UE may be refrained from measuring at least one SSB or at least one CSI-RS whose last OFDM symbol of the at least one measurement gap is received up to a defined number of symbols before a transmission time of a first OFDM symbol of the aperiodic CSI reporting

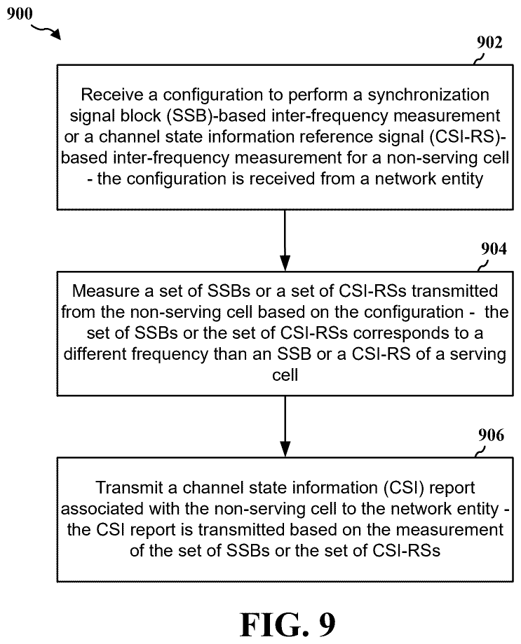

FIG. 9 is a flowchart 900 of a method of wireless communication. The method may be performed by a UE (e.g., the UE 104, 402, 602, 702; the apparatus 1004). The method may enable the UE to perform an SSB/CSI-RS-based inter-frequency measurement for one or more neighboring cells, and to report the measurement for L1/L2 mobility to a network entity (e.g., a base station).

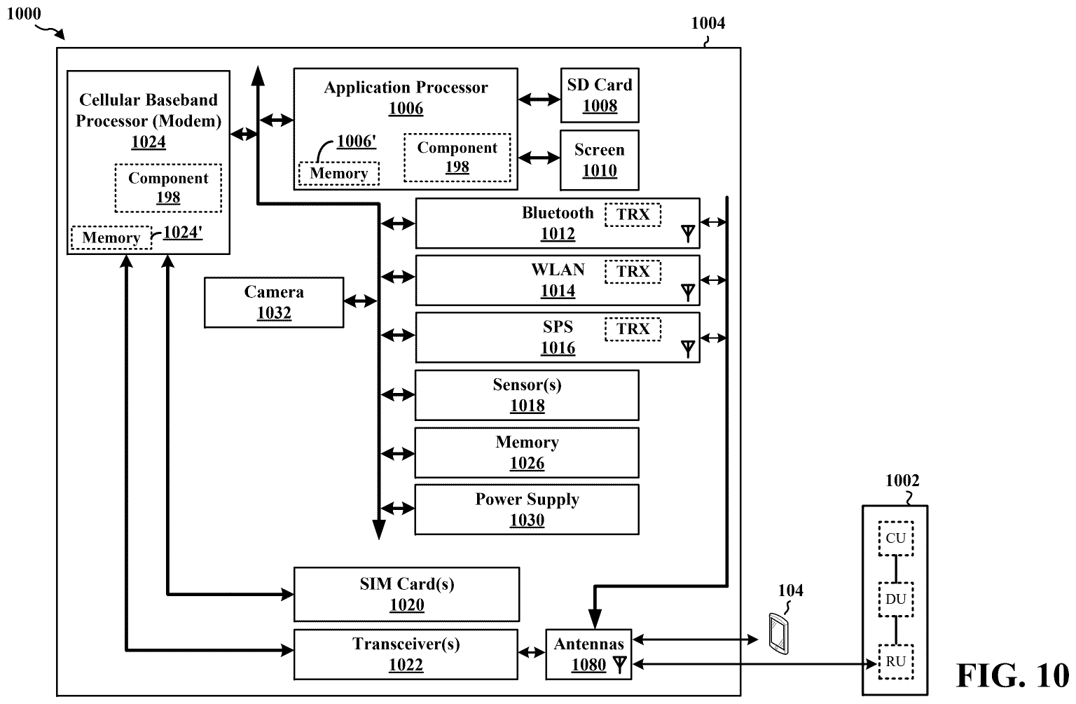

At 902, the UE may receive a configuration to perform an SSB-based inter-frequency measurement or a CSI-RS-based inter-frequency measurement for a non-serving cell, where the configuration is received from a network entity, such as described in connection with FIG. 7. For example, at 720, the UE 702 may receive a configuration 706 from the base station 704 to perform an SSB/CSI-RS-based inter-frequency measurement for non-serving cell(s) 708. The reception of the configuration may be performed by, e.g., the inter-frequency measurement process component 198, the cellular baseband processor 1024, and/or the transceiver(s) 1022 of the apparatus 1004 in FIG. 10.

In one example, the configuration is received via RRC signaling or an RRC message.

In another example, the configuration is associated with the SSB-based inter-frequency measurement, and where the configuration further includes at least one of: inter-frequency information for the set of SSBs, an SCS for at least the set of SSBs, measurement window configuration information, or associated measurement gap configuration information.

In another example, the configuration is associated with the CSI-RS-based inter-frequency measurement, and where the configuration further includes at least one of: inter-frequency information for the set of CSI-RSs, or associated measurement gap configuration information.

At 904, the UE may measure a set of SSBs or a set of CSI-RSs transmitted from the non-serving cell based on the configuration, where the set of SSBs or the set of CSI-RSs corresponds to a different frequency than an SSB or a CSI-RS of a serving cell, such as described in connection with FIG. 7. For example, at 722, the UE 702 may measure a set of SSBs/CSI-RSs 710 from the non-serving cell(s) 708 based on the configuration 706, where the set of SSBs/CSI-RSs 710 has a different frequency than an SSB or a CSI-RS of a serving cell 712. The measurement of the set of SSBs or the set of CSI-RSs may be performed by, e.g., the inter-frequency measurement process component 198, the cellular baseband processor 1024, and/or the transceiver(s) 1022 of the apparatus 1004 in FIG. 10.

In one example, the serving cell includes at least one PCell and the non-serving cell is a neighbor cell.

In another example, the configuration does not include a measurement gap if the set of SSBs or the set of CSI-RSs is contained inside an active DL BWP of the serving cell.

In another example, the configuration includes a measurement gap if the set of SSBs or the set of CSI-RSs is outside of an active DL BWP of the serving cell.

In another example, the configuration further includes the set of SSBs to be measured, or where the configuration further includes at least one configuration parameter for the set of CSI-RSs and a timing reference for the set of CSI-RSs if the set of CSI-RSs is not associated with an SSB.

In another example, the configuration includes at least one measurement gap associated with the measurement of the set of SSBs or the set of CSI-RSs and processing of the CSI report. In such an example, the UE may reserve at least one frequency tuning period before or after the at least one measurement gap, or at a beginning or an end of the at least one measurement gap, and the UE may perform frequency tuning during the at least one frequency tuning period.

In another example, the CSI report is associated with aperiodic CSI reporting. In such an example, the UE may receive an indication to activate the aperiodic CSI reporting from the network entity. In one example, the CSI report is processed during a last OFDM symbol of the at least one measurement gap and a first OFDM symbol of the aperiodic CSI reporting. In another example, the CSI report is processed during a last OFDM symbol of the set of SSBs or the set of CSI-RSs and a first OFDM symbol of the aperiodic CSI reporting. In another example, the UE may refrain from measuring at least one SSB or at least one CSI-RS whose last orthogonal frequency-division multiplexing (OFDM) symbol of the at least one measurement gap is received up to a defined number of symbols before a transmission time of a first OFDM symbol of the aperiodic CSI reporting.

At 906, the UE may transmit a CSI report associated with the non-serving cell to the network entity, where the CSI report is transmitted based on the measurement of the set of SSBs or the set of CSI-RSs, such as described in connection with FIG. 7. For example, at 724, the UE 702 may transmit CSI report 714 associated with the non-serving cell 708 to the base station 704 based on the measurement of the set of SSBs/CSI-RSs 710. The transmission of the CSI report may be performed by, e.g., the inter-frequency measurement process component 198, the cellular baseband processor 1024, and/or the transceiver(s) 1022 of the apparatus 1004 in FIG. 10.

In one example, the CSI report corresponds to a layer one (L1) or a physical layer CSI report.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the inter-frequency measurement process component 198 is configured to receive a configuration to perform an SSB-based inter-frequency measurement or a CSI-RS-based inter-frequency measurement for a non-serving cell, where the configuration is received from a network entity. The inter-frequency measurement process component 198 may also be configured to measure a set of SSBs or a set of CSI-RSs transmitted from the non-serving cell based on the configuration, where the set of SSBs or the set of CSI-RSs corresponds to a different frequency than an SSB or a CSI-RS of a serving cell. The inter-frequency measurement process component 198 may also be configured to transmit a CSI report associated with the non-serving cell to the network entity, where the CSI report is transmitted based on the measurement of the set of SSBs or the set of CSI-RSs. The inter-frequency measurement process component 198 may be within the cellular baseband processor 1024, the application processor 1006, or both the cellular baseband processor 1024 and the application processor 1006. The inter-frequency measurement process component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving a configuration to perform an SSB-based inter-frequency measurement or a CSI-RS-based inter-frequency measurement for a non-serving cell, where the configuration is received from a network entity. The apparatus 1004 may further include means for measuring a set of SSBs or a set of CSI-RSs transmitted from the non-serving cell based on the configuration, where the set of SSBs or the set of CSI-RSs corresponds to a different frequency than an SSB or a CSI-RS of a serving cell. The apparatus 1004 may further include means for transmitting a CSI report associated with the non-serving cell to the network entity, where the CSI report is transmitted based on the measurement of the set of SSBs or the set of CSI-RSs.

In one example, the configuration is received via RRC signaling or an RRC message.

In another example, the configuration is associated with the SSB-based inter-frequency measurement, and where the configuration further includes at least one of: inter-frequency information for the set of SSBs, an SCS for at least the set of SSBs, measurement window configuration information, or associated measurement gap configuration information.

In another example, the configuration is associated with the CSI-RS-based inter-frequency measurement, and where the configuration further includes at least one of: inter-frequency information for the set of CSI-RSs, or associated measurement gap configuration information.

In another example, the serving cell includes at least one PCell and the non-serving cell is a neighbor cell.

In another example, the configuration does not include a measurement gap if the set of SSBs or the set of CSI-RSs is contained inside an active DL BWP of the serving cell.

In another example, the configuration includes a measurement gap if the set of SSBs or the set of CSI-RSs is outside of an active DL BWP of the serving cell.

In another example, the configuration further includes the set of SSBs to be measured, or where the configuration further includes at least one configuration parameter for the set of CSI-RSs and a timing reference for the set of CSI-RSs if the set of CSI-RSs is not associated with an SSB.

In another example, the configuration includes at least one measurement gap associated with the measurement of the set of SSBs or the set of CSI-RSs and processing of the CSI report. In such an example, the apparatus 1004 may further include means for reserving at least one frequency tuning period before or after the at least one measurement gap, or at a beginning or an end of the at least one measurement gap, and means for performing frequency tuning during the at least one frequency tuning period.

In another example, the CSI report is associated with aperiodic CSI reporting. In such an example, the apparatus 1004 may further include means for receiving an indication to activate the aperiodic CSI reporting from the network entity. In one example, the CSI report is processed during a last OFDM symbol of the at least one measurement gap and a first OFDM symbol of the aperiodic CSI reporting. In another example, the CSI report is processed during a last OFDM symbol of the set of SSBs or the set of CSI-RSs and a first OFDM symbol of the aperiodic CSI reporting. In another example, the apparatus 1004 may further include means for refraining from measuring at least one SSB or at least one CSI-RS whose last OFDM symbol of the at least one measurement gap is received up to a defined number of symbols before a transmission time of a first OFDM symbol of the aperiodic CSI reporting.

In another example, the CSI report corresponds to a layer one (L1) or a physical layer CSI report.

The means may be the inter-frequency measurement process component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

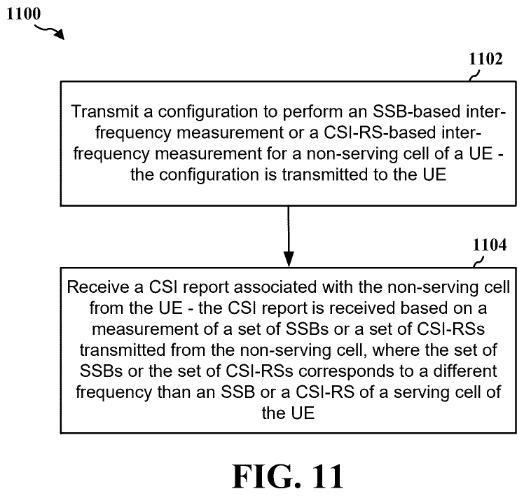

FIG. 11 is a flowchart 1100 of a method of wireless communication. The method may be performed by a base station (e.g., the base station 102, 404, 704; the network entity 1202). The method may enable the base station to configure a UE to perform an SSB/CSI-RS-based inter-frequency measurement for one or more neighboring cells, and to report the measurement for L1/L2 mobility back to the base station.

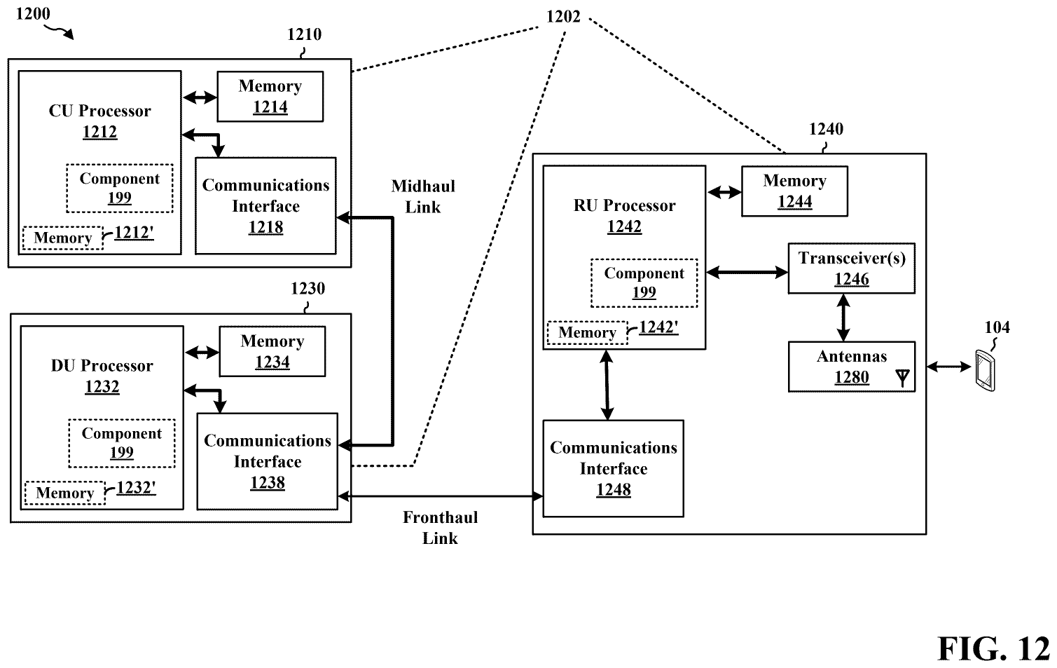

At 1102, the base station may transmit a configuration to perform an SSB-based inter-frequency measurement or a CSI-RS-based inter-frequency measurement for a non-serving cell of a UE, where the configuration is transmitted to the UE, such as described in connection with FIG. 7. For example, at 720, the base station 704 may transmit a configuration 706 to the UE 702 to configure the UE 702 to perform an SSB/CSI-RS-based inter-frequency measurement for non-serving cell(s) 708. The transmission of the configuration may be performed by, e.g., the inter-frequency measurement configuration component 199 and/or the transceiver(s) 1246 of the network entity 1002 in FIG. 12.

In one example, the configuration is transmitted via RRC signaling or an RRC message.

In another example, the configuration is associated with the SSB-based inter-frequency measurement, and where the configuration further includes at least one of: inter-frequency information for the set of SSBs, an SCS for at least the set of SSBs, measurement window configuration information, or associated measurement gap configuration information.

In another example, the configuration is associated with the CSI-RS-based inter-frequency measurement, and where the configuration further includes at least one of: inter-frequency information for the set of CSI-RSs, or associated measurement gap configuration information.

In another example, the serving cell includes at least one PCell and the non-serving cell is a neighbor cell.

In another example, the configuration does not include a measurement gap if the set of SSBs or the set of CSI-RSs is contained inside an active DL BWP of the serving cell.

In another example, the configuration includes a measurement gap if the set of SSBs or the set of CSI-RSs is outside of an active DL BWP of the serving cell.

In another example, the configuration further includes the set of SSBs to be measured, or where the configuration further includes at least one configuration parameter for the set of CSI-RSs and a timing reference for the set of CSI-RSs if the set of CSI-RSs is not associated with an SSB.

In another example, the configuration includes at least one measurement gap associated with the measurement of the set of SSBs or the set of CSI-RSs and processing of the CSI report.

In another example, the CSI report is associated with aperiodic CSI reporting. In such an example, the base station may transmit an indication to activate the aperiodic CSI reporting to the UE.

At 1104, the UE may receive a CSI report associated with the non-serving cell from the UE, where the CSI report is received based on a measurement of a set of SSBs or a set of CSI-RSs transmitted from the non-serving cell, where the set of SSBs or the set of CSI-RSs corresponds to a different frequency than an SSB or a CSI-RS of a serving cell of the UE, such as described in connection with FIG. 7. For example, at 724, the base station 704 may receive a CSI report 714 associated with the non-serving cell 708 from the UE 702 based on the UE 702′s measurement of the set of SSBs/CSI-RSs 710. The reception of the CSI report may be performed by, e.g., the inter-frequency measurement configuration component 199 and/or the transceiver(s) 1246 of the network entity 1002 in FIG. 12.

In one example, the CSI report corresponds to a layer one (L1) or a physical layer CSI report.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the inter-frequency measurement configuration component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the inter-frequency measurement configuration component 199 is configured to transmit a configuration to perform an SSB-based inter-frequency measurement or a CSI-RS-based inter-frequency measurement for a non-serving cell of a UE, where the configuration is transmitted to the UE. The inter-frequency measurement configuration component 199 may also be configured to receive a CSI report associated with the non-serving cell from the UE, where the CSI report is received based on a measurement of a set of SSBs or a set of CSI-RSs transmitted from the non-serving cell, where the set of SSBs or the set of CSI-RSs corresponds to a different frequency than an SSB or a CSI-RS of a serving cell of the UE. The inter-frequency measurement configuration component 199 may be within one or more processors of one or more of the CU 1210, DU 1230, and the RU 1240. The inter-frequency measurement configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for transmitting a configuration to perform an SSB-based inter-frequency measurement or a CSI-RS-based inter-frequency measurement for a non-serving cell of a UE, where the configuration is transmitted to the UE. The network entity 1202 may further include means for receiving a CSI report associated with the non-serving cell from the UE, where the CSI report is received based on a measurement of a set of SSBs or a set of CSI-RSs transmitted from the non-serving cell, where the set of SSBs or the set of CSI-RSs corresponds to a different frequency than an SSB or a CSI-RS of a serving cell of the UE.

In one example, the configuration is transmitted via RRC signaling or an RRC message.

In another example, the configuration is associated with the SSB-based inter-frequency measurement, and where the configuration further includes at least one of: inter-frequency information for the set of SSBs, an SCS for at least the set of SSBs, measurement window configuration information, or associated measurement gap configuration information.

In another example, the configuration is associated with the CSI-RS-based inter-frequency measurement, and where the configuration further includes at least one of: inter-frequency information for the set of CSI-RSs, or associated measurement gap configuration information.

In another example, the serving cell includes at least one PCell and the non-serving cell is a neighbor cell.

In another example, the configuration does not include a measurement gap if the set of SSBs or the set of CSI-RSs is contained inside an active DL BWP of the serving cell.

In another example, the configuration includes a measurement gap if the set of SSBs or the set of CSI-RSs is outside of an active DL BWP of the serving cell.

In another example, the configuration further includes the set of SSBs to be measured, or where the configuration further includes at least one configuration parameter for the set of CSI-RSs and a timing reference for the set of CSI-RSs if the set of CSI-RSs is not associated with an SSB.

In another example, the configuration includes at least one measurement gap associated with the measurement of the set of SSBs or the set of CSI-RSs and processing of the CSI report.

In another example, the CSI report is associated with aperiodic CSI reporting. In such an example, the network entity 1202 may further include means for transmitting an indication to activate the aperiodic CSI reporting to the UE.

In one example, the CSI report corresponds to a layer one (L1) or a physical layer CSI report.

The means may be the inter-frequency measurement configuration component 199 of the network entity 1202 configured to perform the functions recited by the means. As described supra, the network entity _1102 may include the TX processor 316, the RX processor 370, and the controller/processor 375. As such, in one configuration, the means may be the TX processor 316, the RX processor 370, and/or the controller/processor 375 configured to perform the functions recited by the means. It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a configuration to perform an SSB-based inter-frequency measurement or a CSI-RS-based inter-frequency measurement for a non-serving cell, where the configuration is received from a network entity; measuring a set of SSBs or a set of CSI-RSs transmitted from the non-serving cell based on the configuration, where the set of SSBs or the set of CSI-RSs corresponds to a different frequency than an SSB or a CSI-RS of a serving cell; and transmitting a CSI report associated with the non-serving cell to the network entity, where the CSI report is transmitted based on the measurement of the set of SSBs or the set of CSI-RSs.

Aspect 2 is the method of aspect 1, where the CSI report corresponds to an L1 or a physical layer CSI report.

Aspect 3 is the method of any of aspects 1 or 2, where the serving cell includes at least one PCell and the non-serving cell is a neighbor cell.

Aspect 4 is the method of any of aspects 1 to 3, where the configuration is received via RRC signaling or an RRC message.

Aspect 5 is the method of any of aspects 1 to 4, where the configuration does not include a measurement gap if the set of SSBs or the set of CSI-RSs is contained inside an active DL BWP of the serving cell.

Aspect 6 is the method of any of aspects 1 to 5, where the configuration includes a measurement gap if the set of SSBs or the set of CSI-RSs is outside of an active DL BWP of the serving cell.

Aspect 7 is the method of any of aspects 1 to 6, where the configuration further includes the set of SSBs to be measured, or where the configuration further includes at least one configuration parameter for the set of CSI-RSs and a timing reference for the set of CSI-RSs if the set of CSI-RSs is not associated with an SSB.

Aspect 8 is the method of any of aspects 1 to 7, where the configuration is associated with the SSB-based inter-frequency measurement, and where the configuration further includes at least one of: inter-frequency information for the set of SSBs, an SCS for at least the set of SSBs, measurement window configuration information, or associated measurement gap configuration information.

Aspect 9 is the method of any of aspects 1 to 8, where the configuration is associated with the CSI-RS-based inter-frequency measurement, and where the configuration further includes at least one of: inter-frequency information for the set of CSI-RSs, or associated measurement gap configuration information.

Aspect 10 is the method of any of aspects 1 to 9, where the configuration includes at least one measurement gap associated with the measurement of the set of SSBs or the set of CSI-RSs and processing of the CSI report.

Aspect 11 is the method of aspect 10, further including: reserving at least one frequency tuning period before or after the at least one measurement gap, or at a beginning or an end of the at least one measurement gap; and performing frequency tuning during the at least one frequency tuning period.

Aspect 12 is the method of aspect 10, where the CSI report is associated with aperiodic CSI reporting.

Aspect 13 is the method of aspect 12, further including: receiving an indication to activate the aperiodic CSI reporting from the network entity.

Aspect 14 is the method of aspect 12, where the CSI report is processed during a last OFDM symbol of the at least one measurement gap and a first OFDM symbol of the aperiodic CSI reporting.

Aspect 15 is the method of aspect 12, where the CSI report is processed during a last OFDM symbol of the set of SSBs or the set of CSI-RSs and a first OFDM symbol of the aperiodic CSI reporting.

Aspect 16 is the method of aspect 12, further including: refraining from measuring at least one SSB or at least one CSI-RS whose last orthogonal frequency-division multiplexing (OFDM) symbol of the at least one measurement gap is received up to a defined number of symbols before a transmission time of a first OFDM symbol of the aperiodic CSI reporting.

Aspect 17 is an apparatus for wireless communication at a UE, including: a memory; and at least one processor coupled to the memory and, based at least in part on information stored in the memory, the at least one processor is configured to implement any of aspects 1 to 16.

Aspect 18 is the apparatus of aspect 17, further including at least one of a transceiver or an antenna coupled to the at least one processor.

Aspect 19 is an apparatus for wireless communication including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

Aspect 21 is a method of wireless communication at a network node (e.g., a base station), including: transmitting a configuration to perform an SSB-based inter-frequency measurement or a CSI-RS-based inter-frequency measurement for a non-serving cell of a UE, where the configuration is transmitted to the UE; and receiving a CSI report associated with the non-serving cell from the UE, where the CSI report is received based on a measurement of a set of SSBs or a set of CSI-RSs transmitted from the non-serving cell, where the set of SSBs or the set of CSI-RSs corresponds to a different frequency than an SSB or a CSI-RS of a serving cell of the UE.

Aspect 22 is the method of aspect 21, where the CSI report corresponds to an L1 or a physical layer CSI report.

Aspect 23 is the method of aspect 21 or 22, where the configuration is transmitted via RRC signaling or an RRC message.

Aspect 24 is the method of any of aspects 21 to 23, where the configuration does not include a measurement gap if the set of SSBs or the set of CSI-RSs is contained inside an active DL BWP of the serving cell.

Aspect 25 is the method of any of aspects 21 to 24, where the configuration includes a measurement gap if the set of SSBs or the set of CSI-RSs is outside of an active DL BWP of the serving cell.

Aspect 26 is the method of any of aspects 21 to 25, where the configuration further includes the set of SSBs to be measured, or where the configuration further includes at least one configuration parameter for the set of CSI-RSs and a timing reference for the set of CSI-RSs if the set of CSI-RSs is not associated with an SSB.

Aspect 27 is the method of any of aspects 21 to 26, where the configuration is associated with the SSB-based inter-frequency measurement, and where the configuration further includes at least one of: inter-frequency information for the set of SSBs, an SCS for at least the set of SSBs, measurement window configuration information, or associated measurement gap configuration information.

Aspect 28 is the method of any of aspects 21 to 27, where the configuration is associated with the CSI-RS-based inter-frequency measurement, and where the configuration further includes at least one of: inter-frequency information for the set of CSI-RSs, or associated measurement gap configuration information.

Aspect 29 is the method of any of aspects 21 to 28, where the configuration includes at least one measurement gap associated with the measurement of the set of SSBs or the set of CSI-RSs and processing of the CSI report.

Aspect 30 is the method of aspect 29, where the CSI report is associated with aperiodic CSI reporting.

Aspect 31 is the method of aspect 30, further including: transmitting an indication to activate the aperiodic CSI reporting to the UE.

Aspect 32 is an apparatus for wireless communication at a base station, including: a memory; and at least one processor coupled to the memory and, based at least in part on information stored in the memory, the at least one processor is configured to implement any of aspects 21 to 31.

Aspect 33 is the apparatus of aspect 32, further including at least one of a transceiver or an antenna coupled to the at least one processor.

Aspect 34 is an apparatus for wireless communication including means for implementing any of aspects 21 to 31.

Aspect 35 is a computer-readable medium (e.g., a non-transitory computer-readable medium) storing computer executable code, where the code when executed by a processor causes the processor to implement any of aspects 21 to 31.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration to perform a synchronization signal block (SSB)-based inter-frequency measurement or a channel state information reference signal (CSI-RS)-based inter-frequency measurement for a non-serving cell, wherein the configuration is received from a network entity;
measure a set of SSBs or a set of CSI-RSs transmitted from the non-serving cell based on the configuration, wherein the set of SSBs or the set of CSI-RSs corresponds to a different frequency than an SSB or a CSI-RS of a serving cell; and
transmit a channel state information (CSI) report associated with the non-serving cell to the network entity, wherein the CSI report is transmitted based on the measurement of the set of SSBs or the set of CSI-RSs.

2. The apparatus of claim 1, wherein the CSI report corresponds to a layer one (L1) or a physical layer CSI report.

3. The apparatus of claim 1, wherein the serving cell includes at least one primary cell (PCell) and the non-serving cell is a neighbor cell.

4. The apparatus of claim 1, wherein the configuration is received via radio resource control (RRC) signaling or an RRC message.

5. The apparatus of claim 1, wherein the configuration does not include a measurement gap if the set of SSBs or the set of CSI-RSs is contained inside an active downlink (DL) bandwidth part (BWP) of the serving cell.

6. The apparatus of claim 1, wherein the configuration includes a measurement gap if the set of SSBs or the set of CSI-RSs is outside of an active downlink (DL) bandwidth part (BWP) of the serving cell.

7. The apparatus of claim 1, wherein the configuration further includes the set of SSBs to be measured, or wherein the configuration further includes at least one configuration parameter for the set of CSI-RSs and a timing reference for the set of CSI-RSs if the set of CSI-RSs is not associated with an SSB.

8. The apparatus of claim 1, wherein the configuration is associated with the SSB-based inter-frequency measurement, and wherein the configuration further includes at least one of:
inter-frequency information for the set of SSBs,
a subcarrier spacing (SCS) for at least the set of SSBs,
measurement window configuration information, or
associated measurement gap configuration information.

9. The apparatus of claim 1, wherein the configuration is associated with the CSI-RS-based inter-frequency measurement, and wherein the configuration further includes at least one of:
inter-frequency information for the set of CSI-RSs, or
associated measurement gap configuration information.

10. The apparatus of claim 1, wherein the configuration includes at least one measurement gap associated with the measurement of the set of SSBs or the set of CSI-RSs and processing of the CSI report.

11. The apparatus of claim 10, wherein the at least one processor is further configured to:
reserve at least one frequency tuning period before or after the at least one measurement gap, or at a beginning or an end of the at least one measurement gap; and
perform frequency tuning during the at least one frequency tuning period.

12. The apparatus of claim 10, wherein the CSI report is associated with aperiodic CSI reporting.

13. The apparatus of claim 12, wherein the at least one processor is further configured to:
receive an indication to activate the aperiodic CSI reporting from the network entity.

14. The apparatus of claim 12, wherein the CSI report is processed during a last orthogonal frequency-division multiplexing (OFDM) symbol of the at least one measurement gap and a first OFDM symbol of the aperiodic CSI reporting.

15. The apparatus of claim 12, wherein the CSI report is processed during a last orthogonal frequency-division multiplexing (OFDM) symbol of the set of SSBs or the set of CSI-RSs and a first OFDM symbol of the aperiodic CSI reporting.

16. The apparatus of claim 12, wherein the at least one processor is further configured to:
refrain from measuring at least one SSB or at least one CSI-RS whose last orthogonal frequency-division multiplexing (OFDM) symbol of the at least one measurement gap is received up to a defined number of symbols before a transmission time of a first OFDM symbol of the aperiodic CSI reporting.

17. A method of wireless communication at a user equipment (UE), comprising:
receiving a configuration to perform a synchronization signal block (SSB)-based inter-frequency measurement or a channel state information reference signal (CSI-RS)-based inter-frequency measurement for a non-serving cell, wherein the configuration is received from a network entity;
measuring a set of SSBs or a set of CSI-RSs transmitted from the non-serving cell based on the configuration, wherein the set of SSBs or the set of CSI-RSs corresponds to a different frequency than an SSB or a CSI-RS of a serving cell; and
transmitting a channel state information (CSI) report associated with the non-serving cell to the network entity, wherein the CSI report is transmitted based on the measurement of the set of SSBs or the set of CSI-RSs.

18. The method of claim 17, wherein the configuration does not include a measurement gap if the set of SSBs or the set of CSI-RSs is contained inside an active downlink (DL) bandwidth part (BWP) of the serving cell, and wherein the configuration includes the measurement gap if the set of SSBs or the set of CSI-RSs is outside of the DL BWP of the serving cell.

19. An apparatus for wireless communication at a network entity, comprising:
a memory; and
at least one processor coupled to the memory and, based at least in part on information stored in the memory, the at least one processor is configured to:
transmit a configuration to perform a synchronization signal block (SSB)-based inter-frequency measurement or a channel state information reference signal (CSI-RS)-based inter-frequency measurement for a non-serving cell of a user equipment (UE), wherein the configuration is transmitted to the UE; and
receive a channel state information (CSI) report associated with the non-serving cell from the UE, wherein the CSI report is received based on a measurement of a set of SSBs or a set of CSI-RSs transmitted from the non-serving cell, wherein the set of SSBs or the set of CSI-RSs corresponds to a different frequency than an SSB or a CSI-RS of a serving cell of the UE.

20. The apparatus of claim 19, wherein the CSI report corresponds to a layer one (L1) or a physical layer CSI report.

21. The apparatus of claim 19, wherein the configuration is transmitted via radio resource control (RRC) signaling or an RRC message.

22. The apparatus of claim 19, wherein the configuration does not include a measurement gap if the set of SSBs or the set of CSI-RSs is contained inside an active downlink (DL) bandwidth part (BWP) of the serving cell.

23. The apparatus of claim 19, wherein the configuration includes a measurement gap if the set of SSBs or the set of CSI-RSs is outside of an active downlink (DL) bandwidth part (BWP) of the serving cell.

24. The apparatus of claim 19, wherein the configuration further includes the set of SSBs to be measured, or wherein the configuration further includes at least one configuration parameter for the set of CSI-RSs and a timing reference for the set of CSI-RSs if the set of CSI-RSs is not associated with an SSB.

25. The apparatus of claim 19, wherein the configuration is associated with the SSB-based inter-frequency measurement, and wherein the configuration further includes at least one of:
inter-frequency information for the set of SSBs,
a subcarrier spacing (SCS) for at least the set of SSBs,
measurement window configuration information, or
associated measurement gap configuration information.

26. The apparatus of claim 19, wherein the configuration is associated with the CSI-RS-based inter-frequency measurement, and wherein the configuration further includes at least one of:
inter-frequency information for the set of CSI-RSs, or
associated measurement gap configuration information.

27. The apparatus of claim 19, wherein the configuration includes at least one measurement gap associated with the measurement of the set of SSBs or the set of CSI-RSs and processing of the CSI report.

28. The apparatus of claim 27, wherein the CSI report is associated with aperiodic CSI reporting.

29. The apparatus of claim 28, wherein the at least one processor is further configured to:
transmit an indication to activate the aperiodic CSI reporting to the UE.

30. A method of wireless communication at a network node, comprising:
transmitting a configuration to perform a synchronization signal block (SSB)-based inter-frequency measurement or a channel state information reference signal (CSI-RS)-based inter-frequency measurement for a non-serving cell of a user equipment (UE), wherein the configuration is transmitted to the UE; and
receiving a channel state information (CSI) report associated with the non-serving cell from the UE, wherein the CSI report is received based on a measurement of a set of SSBs or a set of CSI-RSs transmitted from the non-serving cell, wherein the set of SSBs or the set of CSI-RSs corresponds to a different frequency than an SSB or a CSI-RS of a serving cell of the UE.
